(19) United States
(12) Patent Application Publication
(10) Pub. No.: US 2008/0170860 A1
(43) Pub. Date: Jul. 17, 2008

(54) Method for Transferring Data Packets

(76) Inventor: Miguel De Vega Rodrigo, Woluwe St. Lambert Brussels (BE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/885,818

(22) PCT Filed: Feb. 23, 2006
(86) PCT No.: PCT/EP2006/060230

§ 371 Date: Sep. 6, 2007

(30) Foreign Application Priority Data
Mar. 9, 2005 (DE) 10 2005 010 918.7

(51) Int. Cl. H04B 10/00

(52) U.S. Cl. 398/128

(57) ABSTRACT

Different transfer time periods are allocated to a network node for a connection, according to different quality classes. During the allocated transfer time period, the network node can transfer data bursts and data packets on the fly. The data packet is no longer transferred when the transfer capacity is required elsewhere.

### CROSS REFERENCE TO RELATED APPLICATIONS

This application is the U.S. National Stage of International Application No. PCT/EP2006/060230, filed Feb. 23, 2006 and claims the benefit thereof. The International Application claims the benefits of German application No. 102005010918.7 DE filed Mar. 9, 2005, both of the applications are incorporated by reference herein in their entirety.

### FIELD OF INVENTION

The invention relates to a method for transferring data packets between network nodes of an optical network, according to the independent claims.

### BACKGROUND OF INVENTION

Data transmission via future optical networks can take place by means of so-called “optical burst switching (OBS)”. Here multiple data packets (e.g. IP packets) can be accumulated into so-called data bursts, and then sent via a data channel of a correspondingly designed optical network. The data channel corresponds to a specified wavelength of a wavelength multiplex signal (WDM/DWDM), which transmits multiple individual optical signals (channels) via one optical fiber simultaneously. Via one of these transmission channels, multiple different messages can be transmitted, and sequences of bursts are assigned to each of them. With relatively high traffic density, greater delays in sending data bursts occur, since fewer free time slots are available for transmission. With even higher traffic density, blockages occur.

With a different network concept, so-called λ switching, in which multiple wavelengths (channels) of a WDM/DWDM system are available for transmission, the switching granularity is a wavelength. Consequently, even with low traffic density, a complete transmission channel is occupied; this is called a high “wavelength consumption”, which is correspondingly expensive. Neither of these known methods is optimal on the basis of the essential criteria: time delay, probability of blocking and use of the transmission channel.

An improved transmission method, called APSON (“adaptive path switched network”), is described in an older application, reference 10339039. After transmission of a data burst, the transmission channel remains open for transmission of further data packets “on the fly” of the same end node. Transmission is interrupted only when another node requires the transmission capacity. The decisive advantage of this method results from the continued existence of the transmission channel after the transmission of a data burst. During this so-called consecutive phase, data packets are transmitted “on the fly” with no or minimal delay, since they are not first combined into a burst. The free transmission capacity is used until the data channel, if no other data channel or other wavelength is available, is required by another connection for transmission of its data packets, which are combined into bursts.

The quality of transmission (quality of service (QoS)) concerns the items of blocking in the transmission of bursts, their delay and the delay jitter. To be able to offer the customer a satisfactory service as required, the priority classes for the transmission of data bursts were introduced. For high priority classes, use of longer bursts was proposed, and for low priority classes, transmission of shorter bursts was proposed. However, in practice these proposals have the opposite of the desired effect; bursts with high priority often have longer delay times, because of the higher offset time.

Jingxuan LIU and Nirwan ASARI, in the article “Forward Resource Reservation for Provisioning in OBS Systems”, IEEE 2002, pp. 2777-2781, describe an OBS system which uses different quality classes. The aim is to reduce the delay time until a burst is sent in the highest class which is provided for real time traffic. For this purpose, in the class which is provided for real time traffic, the time until the end of the burst is calculated, and a header packet to reserve transmission time is sent. However, this is insufficient for transmission with the highest quality requirements. A remedy for blockage problems is not discussed.

The same problem is discussed in the reference item “Offset Time Decision (OTD) Algorithm for Guaranteeing the Requested QoS of High Priority Traffic in OBS Networks”, Won-Ho S O et al., APOC 2001, Beijing, China, pp. 286-295. The core of this reference item is the calculation of a “Burst Loss Rate” of an “Offset Time”. Quality improvements are to be expected only indirectly, through other measures which are not described.

In the article by Yong WAN and Byrav RAMAMURTHY, “CPQ: A CONTROL PACKET Queuing Optical Burst Switching Protocol for Supporting QoS”, Broadnets 2004, San Jose, USA, October 2004, an OBS system which has two quality classes for real time traffic and not real time traffic, and uses a further developed JET (Just Enough Time) protocol, is described. Real time traffic is entitled to priority in the reservation of bandwidth (=transmission time). Extension of the “Offset Time” is intended to reduce the probability of blocking. This method too is unsuitable for higher quality requirements, and can also reduce the probability of blocking only temporarily.

A. H. ZAIM et al., “Jumpstart just-in-time signaling protocol: a formal description using extended finite state”, Optical Engineering SPIE USA, Vol. 42 (2), pp. 568-585, XP-002382038, ISSN 00913286, describes a burst transmission system which also provides “persistent path connections”, during the existence of which an arbitrary number of short bursts are transmitted.

In A. KAHEEL et al., a burst transmission system, which has different QoS (Quality of Service) classes and uses a new reservation scheme “Preemptive Prioritized Just Enough Time”, is described.

### SUMMARY OF INVENTION

The object of the invention is therefore to give an improved and more effective method of transmitting data packets with different quality requirements.

Such a method is given in the independent claims.

Advantageous developments of the methods are given in the dependent claims.

The basic idea consists of the use of different burst lengths and a different “reservation time” for different quality classes.

In the highest, “first” quality class, burst transmission no longer takes place. Instead, the IP packets are transmitted via a reserved connection, practically without delay, until there is no more data to transmit. The advantages are minimal delay of the data packets and minimal delay jitter.

As the quality class becomes lower, the reservation times in connection with a data burst become smaller and smaller until they do not even reach the full length of a shortened data burst. This lowest quality class, here the fourth, is therefore restricted in practice to the use of free capacity, whereas the highest quality class comprises the whole transmission channel if required.

### BRIEF DESCRIPTION OF THE DRAWINGS

The method is explained in more detail for the various quality classes with reference to the figures and exemplary embodiments.

FIG. 1 shows a transmission network with multiple network nodes,

FIG. 2 shows a timing diagram for transmission in the highest quality class,

FIG. 3 shows a timing diagram for transmission in a second-highest quality class,

FIG. 4 shows a timing diagram for transmission in a lower quality class,

FIG. 5 shows a timing diagram for transmission in a lowest quality class, and

FIG. 6 shows a comparison of the quality classes.

### DETAILED DESCRIPTION OF INVENTION

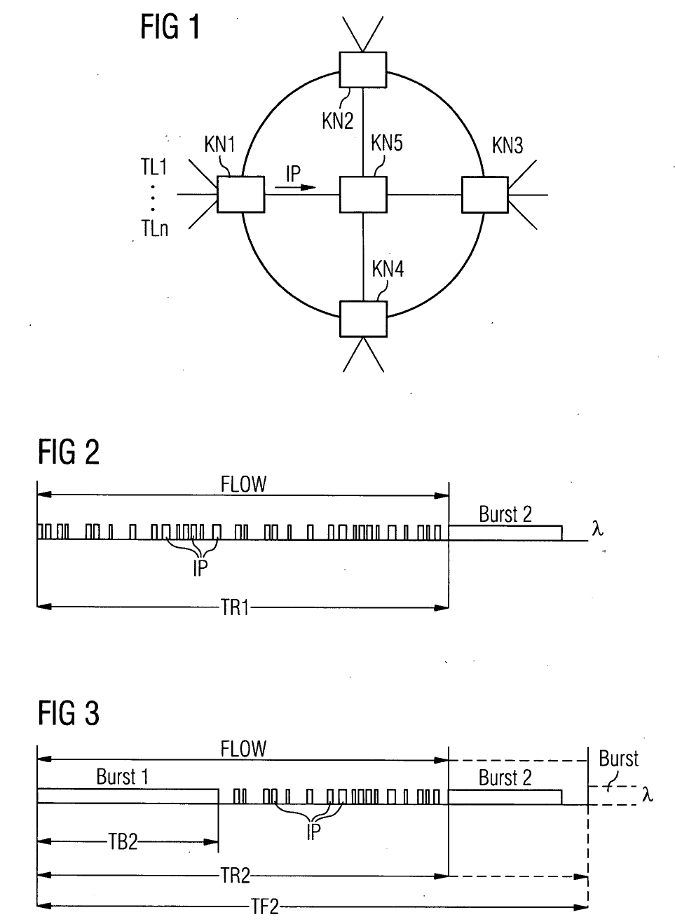

In FIG. 1, a transmission network with multiple network nodes NK1 to NK5 is shown. From subscribers who are connected at any one time to a network node NK1, data is transmitted in the form of data packets (IP packets) to the network node, combined there into data bursts, and then transmitted to a target network node, e.g. network node NK3. For simplicity, it is assumed that the data of all subscribers who are connected to network node NK1 is to be transmitted in the same quality class.

FIG. 2 shows the transmission of the data packets IP from network node NK1 in the highest (first) quality class QK1 (FIG. 6). Practically a complete transmission channel is reserved for the transmission, so that all data packets IP are sent on from network node NK1 directly, without previously being combined into data bursts. The transmission FLOW is ended only when the sending network node NK1 so determines.

In the case of multiple transmissions in the highest quality class, an attempt is made to make two channels (wavelengths) available. Of course, in addition to the quality classes, priority classes can be introduced, so that a request to transmit with the same quality class but a higher priority class results in interruption or restriction of transmission “on the fly” after the guaranteed transmission time. In this case, control is by the network management system. However, the system should be designed so that effects in the highest priority class do not occur.

FIG. 2 shows the transmission of the whole data set FLOW of data packets IP during the reserved time TR1. After the end of transmission, the connection is available, e.g. for transmission of other data, beginning with a data burst “Burst 2” in a lower quality class.

In the case of a second highest quality class, transmission takes place according to the diagram given in FIG. 3. A guaranteed transmission time RT2 is provided for transmission. During this time, a data burst Burst 1 of considerable length TB2 can take place, followed, in the case that a memory of the network node is already empty, by transmission of the subsequent data packets “on the fly”. With low load on the transmission capacity, the result can be that the data packets IP, as in the case of the highest quality class, are transmitted directly, without being combined into bursts. With larger data quantities, mixed transmission of data bursts and data packets takes place. If the bursts are chosen to be short, the delay jitter is also slight. Transmission of data packets outside the guaranteed transmission time RT2 is ended after a duration TF2 only if the transmission channel is required for transmission of the same or higher quality class (shown dashed). For instance, the request can come from another network node (NK2, . . . ) or from the same network node, which combines subscribers of different classes into different quality classes. However, the guaranteed transmission time RT2 is always retained. Additionally, a specified proportion of the transmission capacity of the transmission channel is guaranteed.

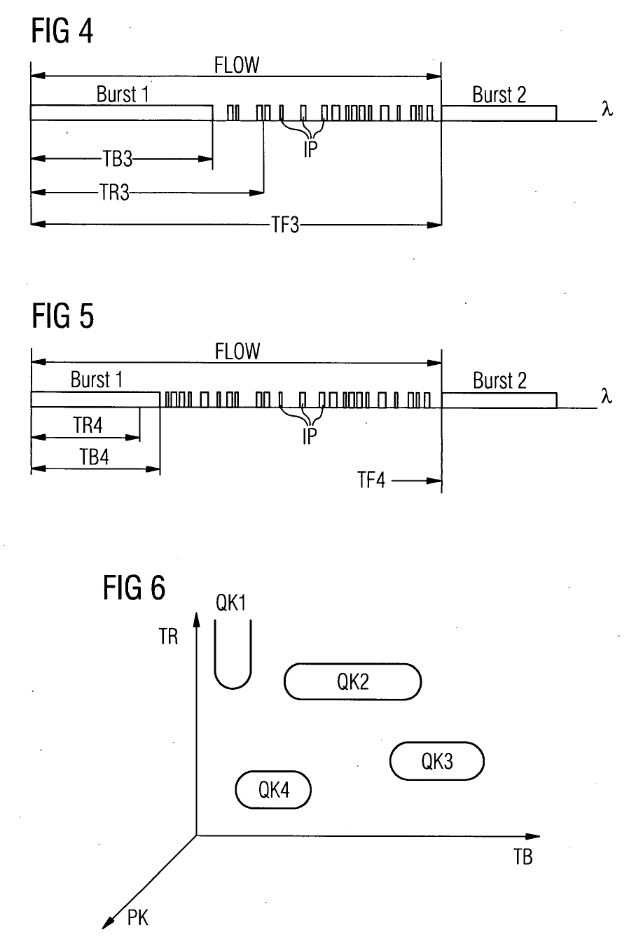

FIG. 4 shows transmission in a lower third quality class QK3. The guaranteed transmission time RT3 is significantly less than in the next higher quality class. Usually, therefore, transmission is carried out essentially in the form of data bursts (Burst 1), the burst transmission time TB3 being below the guaranteed transmission time RT3. Here too, transmission of data packets after transmission of a data burst is ended after the transmission time TF3 only if the transmission capacity is required for transmission of a further data set of the same or higher quality class. In the case of a lightly loaded network, therefore, transmission takes place in the form of data packets IP, and thus with maximum quality. In the case of a more heavily loaded network, delay and delay jitter are still moderate.

In FIG. 5, transmission in the case of a lowest fourth quality class QK4 is shown. In this case, the guaranteed transmission time RT4 can even be below the usual burst length. Additional data packets can be transmitted “on the fly” following the data burst only if the data network is not loaded to capacity. Here too, data transmission is interrupted after a variable time TF4 only if other messages of the same or higher quality class are to be transmitted, but even transmission in the form of data bursts is not yet guaranteed. Of course this quality class has the advantage of being specially inexpensive, but serious quality problems may have to be accepted.

Of course, divisions into further quality classes and additional priority classes can be carried out, with an arbitrary ratio of guaranteed transmission times.

FIG. 6 shows again, in summary, the essential properties of quality classes QK1-QK4, which here are all assigned to one quality class. Corresponding to the burst length which can be chosen, the quality classes QK and priority classes PK, a wide range of transmission properties can be defined.

1.-6. (canceled)

7. A method for transferring data packets via data channels between nodes of an optical network, said data packets being combined into data bursts if required, comprising:
assigning in a first priority class an unlimited transmission time span to a first sending network node for sending data bursts and data packets;
ending transmission of the data packets by the first node;
assigning, in a lower second quality class, limited but guaranteed transmission time spans to a second sending network node;
continuing transmission of the second node after expiry of a first guaranteed transmission time span; and
ending the transmission of the second node only by a request for transmission time in a higher or equal quality class.

8. The method as claimed in claim 7, wherein in a third quality class, a second guaranteed transmission time span, which is less than the second guaranteed transmission time span, is assigned to a sending network node, and in that after expiry of a second guaranteed transmission time span, transmission continues and is ended only by the request for transmission time in a higher or equal quality class.

9. The method as claimed in claim 8, wherein in a lowest quality class, a fourth guaranteed transmission time span, which is equal to or less than a possible burst length (T_{B}), is assigned to a sending network node, and after expiry of the fourth guaranteed transmission time span, transmission continues and is ended only by the request for transmission time in a higher quality class.

10. The method as claimed in claim 7, wherein data packets of the same priority class are combined into data bursts, which are transmitted during the guaranteed transmission time span and in that after the guaranteed transmission time span data packets are transmitted.

11. The method as claimed in claim 7, wherein the guaranteed transmission time is transmitted in a header of the data burst.

12. The method as claimed in claim 7, wherein a guaranteed proportion of the whole transmission capacity of a channel is assigned to each sending network node, corresponding to the quality class.
